(19) United States
(12) Patent Application Publication
(10) Pub. No.: US 2013/0319630 A1
(43) Pub. Date: Dec. 5, 2013

(54) VEHICULAR AIR-CONDITIONING SYSTEM

(71) Applicants: Yuudai Yamamoto, Kariya-shi (JP); Tatsuya Toyama, Kariya-shi (JP); Masashi Mizutani, Kariya-shi (JP); Takayuki Shimauchi, Kariya-shi (JP)

(72) Inventors: Yuudai Yamamoto, Kariya-shi (JP); Tatsuya Toyama, Kariya-shi (JP); Masashi Mizutani, Kariya-shi (JP); Takayuki Shimauchi, Kariya-shi (JP)

(73) Assignee: DENSO CORPORATION, Kariya-shi, Aichi (JP)

(21) Appl. No.: 13/985,009

(22) PCT Filed: Oct. 3, 2011
(86) PCT No.: PCT/JP2011/073167

§ 371 Date: Aug. 12, 2013

(30) Foreign Application Priority Data
Feb. 22, 2011 (JP) 2011-035458

(51) Int. Cl. B60H 1/00

(52) U.S. Cl. CPC B60H 1/00021
USPC 165/42

(57) ABSTRACT

An air conditioning device for a vehicle, provided with: an air blower unit having a first introduction path and a second introduction path through which inside air or outside air is sucked into an upper fan and a lower fan by switching between switching doors; and an air conditioning unit for discharging air into the vehicle interior. The air conditioning device for a vehicle is characterized in that the first introduction path is an introduction path into which only the outside air is introduced when the inside air and the outside air are sucked separately and in that an outside air amount adjustment mechanism for limiting the amount of delivery of the outside air according to the speed of the vehicle is provided in the first introduction path or at a position downstream thereof to reduce the generation of wind noise at a defroster opening or a face opening.

### TECHNICAL FIELD

The present invention relates to a vehicular air-conditioning system which is designed to suppress the occurrence of a whistling sound due to slight door opening and to prevent detraction of comfort in air blown in a passenger compartment due to an increase in the flow rate of air due to the ram pressure (pressure of air due to movement of vehicle).

### BACKGROUND ART

At the time of the FOOT (foot) mode which blows air-conditioned air toward the feet of the driver and passengers, sometimes an extremely large amount of air-conditioned air is distributed through the FOOT vents and a slight flow rate of air is blown through the DEF (defroster) vents to the vehicle windshield side to defog the vehicle windshield. In such a FOOT mode, sometimes the vent mode door is operated to a slightly open position. In this case, the flow of air is rapidly throttled by the slight clearances of the DEF vents and FACE vents and air is ejected through the slight clearances at a fast speed, so there is the problem of a whistling sound being caused.

To deal with this problem, there is known PLT 1 which is aimed at suppressing the occurrence of problems due to the slightly open position of a vent mode door. FIG. 1A is a schematic cross-sectional view of an air-conditioning unit of PLT 1, while FIG. 1B shows the ratio of flow rates of air and door patterns of different modes in PLT 1. Below, the vehicular air-conditioning system of PLT 1 will be simply explained.

The vehicular air-conditioning system of PLT 1 is divided into two parts: an air-conditioning unit 10 and a blower unit 9 which blows air to this air-conditioning unit 10. The blower unit 9 is arranged inside the instrument panel at the front of the passenger compartment while offset from the center part to the front passenger seat side. As opposed to this, the air-conditioning unit 10 is arranged inside the instrument panel at the front of the passenger compartment at the substantially center part in the left-right (width) direction of the vehicle. The air-conditioning unit 10 has a plastic air-conditioning case 11 in which is formed an air passage through which air is blown toward the inside of the passenger compartment. Inside this air-conditioning case 11, an evaporator 12 which forms the cooling-use heat exchanger and a heater core 13 which forms the heating-use heat exchanger are installed. At a portion inside the air-conditioning case 11 at the front-most side of the vehicle, an air inlet space 14 is formed. Into this air inlet space 14, air blown from a centrifugal type blower of the blower unit 9 flows.

Inside of the air-conditioning case 11, the evaporator 12 is arranged at the portion right after the air inlet space 14. This evaporator 12, as is well known, absorbs the latent heat of evaporation of a low pressure refrigerant of a refrigeration cycle from the blown air to cool the blown air. Further, at the downstream side of the flow of air of the evaporator 12 (vehicle rear side), the heater core 13 is arranged a predetermined distance from the evaporator 12. The heater core 13 reheats the cold air which passes through the evaporator 12. At the inside, high temperature water (engine cooling water) flows from the vehicle engine. This warm water is used as a heat source to heat the air.

The air passage of the air which passes through the upstream side of the flow of air of the heater core 13 is partitioned by a first upstream side partition member 15 inside the air-conditioning case 11 to an upstream side first upstream side passage 16 and a downstream side second upstream side passage 17. This first upstream side partition member 15 is formed so as to extend from an air outlet side of the evaporator 12 to an air inlet side of the heater core 13 and is formed to extend across the entire length in the left-right direction of the vehicle in the space inside the air-conditioning case 11. In the air passage of the air-conditioning case 11, at the upper portion and lower portion of the heater core 13, a first bypass passage 18 and a second bypass passage 19 which bypass the heater core 13 and through which air (cold air) flows are formed. The second upstream side passage 17 at the upstream side of the heater core 13 is formed so that the passage cross-sectional area becomes larger than the passage cross-sectional area of the first upstream side passage 16 (for example, a 1:9 ratio).

Between the evaporator 12 and the heater core 13, a first air mix door 20 and a second air mix door 21 are arranged. The air mix doors 20 and 21 are configured by flat-plate shaped sliding doors. The air mix doors 20 and 21 are moved in a direction intersecting the flow of air of the air passage by drive gears 20a and 21a so as to open and close the air passage. The first air mix door 20 and the second air mix door 21 form temperature adjusting means for adjusting the temperature of the air blown to the windshield inside the passenger compartment and the passenger side inside the passenger compartment by adjustment of the ratio of flow rates of air.

At the downstream side of the flow of air of the heater core 13 (vehicle rear side), a first downstream side partition member 22 which extends upward from a position on a line extending from the first upstream side partition member 15 to the vehicle rear is provided. Furthermore, from the end of the first downstream side partition member 22, a first switching door 23 is provided so as to extend to the top wall surface of the air-conditioning case 11 between the defroster vents 26 and face vents 28. The first switching door 23 is arranged to be able to rotate about a rotary shaft 23a. Due to this first downstream side partition member 22 and first switching door 23, a first downstream side passage 24 which guides air to the defroster vents 26 and a second downstream side passage 25 which guides air to the face vents 28 and foot vents 30 are formed. The defroster vents 26, face vents 28, and foot vents 30 are respectively opened and closed by a plate-shaped defroster door 27, face door 29, and foot door 31 which can rotate about rotary shafts 27a, 29a, and 31a.

If the first switching door 23 is operated to the one-dot chain position of FIG. 1, the first switching door 23 closes the connection of the first downstream side passage 24 and the second downstream side passage 25 (this being referred to as the “partitioned position”). As opposed to this, if the first switching door 23 is operated to the solid line position of FIG. 1, the first downstream side passage 24 and the second downstream side passage 25 are communicated (this being referred to as the “communicated position”).

At the time of the foot mode, the defroster vents 26 and foot vents 30 are fully opened by the respectively corresponding vent mode doors 27 and 31. The opening degree of the defroster vents 26 is not limited to fully opened. For example, a half opened extent, not a slightly open position, is also possible. The face vents 28 are closed by the face door 29. The first switching door 23, as shown by the one-dot chain line of FIG. 1, is operated to the “partitioned position” which partitions the passage to the first downstream side passage 24 and the second downstream side passage 25 at the downstream side of the heater core 13. Due to the first upstream side partition member 15, the passage cross-sectional area of the second upstream side passage 17 is formed larger than the passage cross-sectional area of the first upstream side passage 16, so the air which passes through the evaporator 12 mainly flows to the second upstream side passage 17 and a slight flow rate of air flows to the first upstream side passage 16.

In the foot/defroster mode, in the same way as the foot mode, the defroster vents 26 and foot vents 30 are fully opened by the corresponding vent mode doors 27 and 31, while the face vents 28 are closed by the face door 29. The first switching door 23, as shown by the solid line position of FIG. 1, is operated to the “communicated position” which communicates the first downstream side passage 24 and the second downstream side passage 25 at the downstream side of the heater core. Due to this, compared with the foot mode, it is possible to increase the flow rate of the air which passes through the defroster vents 26.

In this way, in the art of PLT 1, in the foot mode, even if not setting the defroster door 27 at the slightly open position, it is possible to blow mainly air from the foot vents 30 and make the flow rate of air which flows into the defroster vents 26 a slight flow rate. For this reason, it is possible to make the flow ratio of air which is blown out from the defroster vents 26 and foot vents 30 a suitable ratio and possible to suppress problems such as the abnormal sound which occurs due to the slightly open position of the defroster door 27

In the art of this PLT 1, as explained above, it is possible to suppress the occurrence of a whistling sound due to the slight door opening. However, the switching door is set to a state where it is fastened at the partitioned position or the communicated position, so when the vehicle is moving at a high speed in the outside air mode, the ram pressure applied to the front surface of the vehicle (pressure generated by being pushed in from the outside when moving) causes the rise in pressure at the scroll casing outlet of the blower to end up increasing. For this reason, due to the increase in the flow rate of air flowing into the passenger compartment and the air-conditioned air in the passenger compartment ending up being changed and due to the feeling on the part of the driver and passengers of the speed of the flow ending up becoming greater than targeted, there is the problem that comfort is not obtained. Further, since the ratio of top and bottom flow rates of air is fixed, to comply with specific vehicle specifications, it is necessary to completely change the top and bottom partitioned position and the layout accompanying the same. The problem of the greater cost and work also arises.

### CITATIONS LIST

### Patent Literature

PLT 1: Japanese Unexamined Patent Publication No. 2009-113538A

PLT 2: Japanese Patent Unexamined Publication No. 2000-016050A

### SUMMARY OF INVENTION

### Technical Problem

The present invention, in consideration of the above problems, provides a vehicular air-conditioning system which is designed to suppress the occurrence of a whistling sound due to a slight door opening and to prevent comfort being detracted from due to the increase in the air flow rate due to the ram pressure.

### Solution to Problem

To solve the above problems, the aspect of the invention of claim 1 provides a vehicular air-conditioning system which is provided with a blower unit (9) which has an upper fan (52), a lower fan (53), switching doors (67, 68, 69, 67′, 68′) for switching passages, a first introduction passage (71) which sucks inside air or outside air into the upper fan (52), a second introduction passage (70) which sucks inside air or outside air into the lower fan (53), and a first discharge passage (81) and second discharge passage (82) which discharge air blown from the upper fan (52) and the lower fan (53) in a two-layer state and an air-conditioning unit (10) which adjusts the temperature of air blown from the blower unit (9) by an evaporator (12), air mix door, and heater core (13) and blows air out from defroster vents (26), face vents (28), and foot vents (30) into the passenger compartment, wherein the first introduction passage (71) is an introduction passage in which only outside air is introduced when sucking in inside air and outside air separately, which is provided with an outside air flow adjustment mechanism which limits the amount of outside air which is blown in accordance with the vehicle speed at the first introduction passage (71) or downstream, and which suppresses the occurrence of a whistling sound of the defroster vents (26) or the face vents (28).

Due to this, even if not opening the defroster door or face door slightly, the flow rate of air which flows through the top side can be adjusted, so it is possible to keep down the occurrence of a whistling sound due to slight door opening while adjusting the flow rate of air to a suitable level in response to an increase in the flow rate of air due to ram pressure at the time when the vehicle is moving at a high speed without detracting from comfort.

The aspect of the invention of claim 2 provides the aspect of the invention of claim 1, wherein the first introduction passage (71) and the second introduction passage (70) have inside air or outside air introduced by three suction modes of a two-layer inside/outside air mode which sucks in the inside air and outside air separately, an outside air mode, and an inside air mode.

The aspect of the invention of claim 3 provides the aspect of the invention of claims 1 and 2, wherein the first introduction passage (71) communicates with the defroster vents (26) and the face vents (28), and the second introduction passage (70) communicates with the foot vents (30).

The aspect of the invention of claim 4 provides the aspect of the invention of any one of claims 1 to 3, wherein the outside air flow adjustment mechanism is a throttling door (72) which is provided at the first introduction passage (71). Due to this, advantageous effects the same as the aspect of the invention of claim 1 can be obtained, the amount of work imposed on the fan can be reduced, and an energy saving effect can be obtained.

The aspect of the invention of claim 5 provides the aspect of the invention of any one of claims 1 to 3, wherein the outside air flow adjustment mechanism is an iris shutter type throttling door (75) which is provided at the first introduction passage (71). Due to this, advantageous effects the same as in the aspect of the invention of claim 4 are obtained.

The aspect of the invention of claim 6 provides the aspect of the invention of any one of claims 1 to 3, wherein the outside air flow adjustment mechanism is a throttling door (78) which is provided at a first discharge passage (81) which extends from the upper fan (52) to the evaporator (12). Due to this, advantageous effects the same as in the aspect of the invention of claim 1 are obtained.

The aspect of the invention of claim 7 provides the aspect of the invention of any one of claims 1 to 3, wherein the outside air flow adjustment mechanism is an opening/closing door (79) which is provided at an up-down passage partitioning member (73) between a first discharge passage (81) which extends from the upper fan (52) to the evaporator (12) and a second discharge passage (81) which extends from the lower fan (52) to the evaporator (12). Due to this, advantageous effects the same as in the aspect of the invention of claim 1 are obtained.

The aspect of the invention of claim 8 provides the aspect of the invention of any one of claims 1 to 3, wherein the outside air flow adjustment mechanism is a variable nose part clearance mechanism (83) which is provided at a nose part of the upper fan (52). Due to this, advantageous effects the same as in the aspect of the invention of claim 4 are obtained.

Note that the reference numerals given above are illustrations showing the correspondence with specific means described in the embodiments described later.

### BRIEF DESCRIPTION OF DRAWINGS

FIG. 1(a) is a schematic cross-sectional view of an air-conditioning unit of PLT 1, while FIG. 1(b) shows the ratios of flow rates of air flow and door patterns of different modes of PLT 1.

FIG. 2 is a schematic explanatory view of an inside/outside air suction FOOT mode in an embodiment of the present invention.

FIG. 3 is a schematic explanatory view of an outside air suction FOOT mode in an embodiment of the present invention.

FIG. 4 is a schematic explanatory view of an inside/outside air suction FOOT mode in a modification of a suction port switching door of an embodiment of the present invention.

FIG. 5 is a cross-sectional view of an air-conditioning unit of an embodiment of the present invention.

FIG. 6(a) is an explanatory view which shows another embodiment of an outside air flow adjustment mechanism, while FIG. 6(b) is a schematic view which shows an iris shutter type throttling door 75.

FIG. 7 is an explanatory view which shows another embodiment of an outside air flow adjustment mechanism (at time of inside/outside air suction FOOT mode).

FIG. 8 is an explanatory view which shows another embodiment of an outside air flow adjustment mechanism (at time of inside/outside air suction FOOT mode).

FIG. 9 is an explanatory view which shows another embodiment of an outside air flow adjustment mechanism.

### DESCRIPTION OF EMBODIMENTS

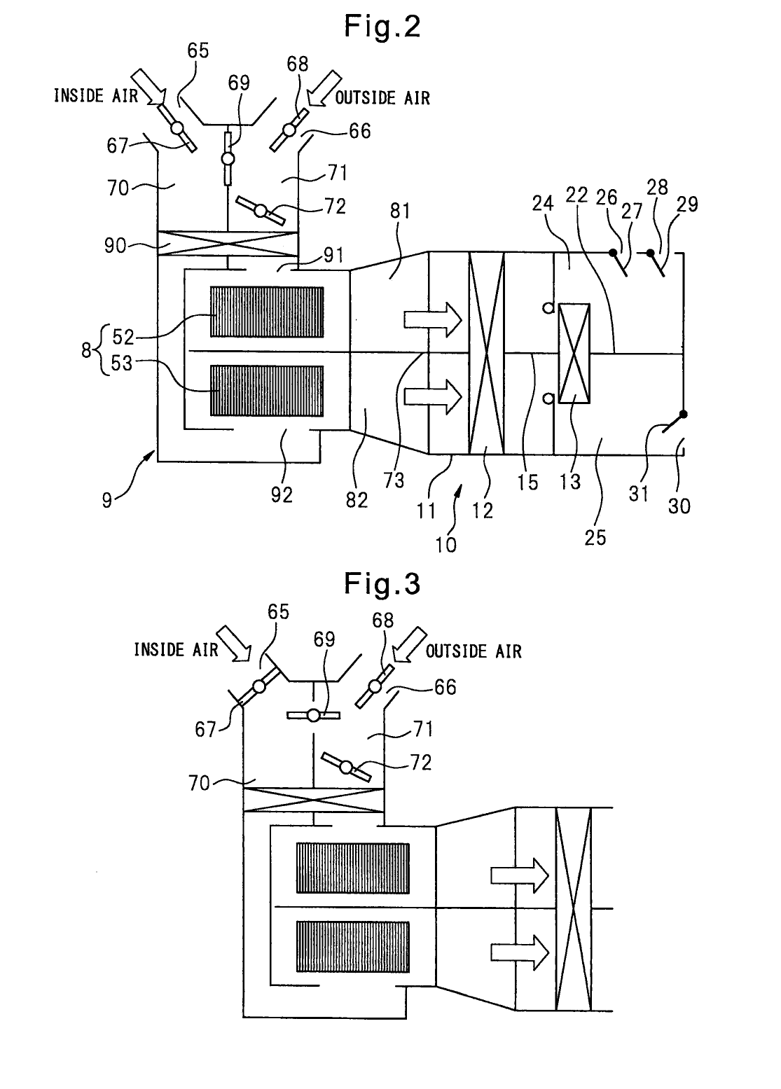

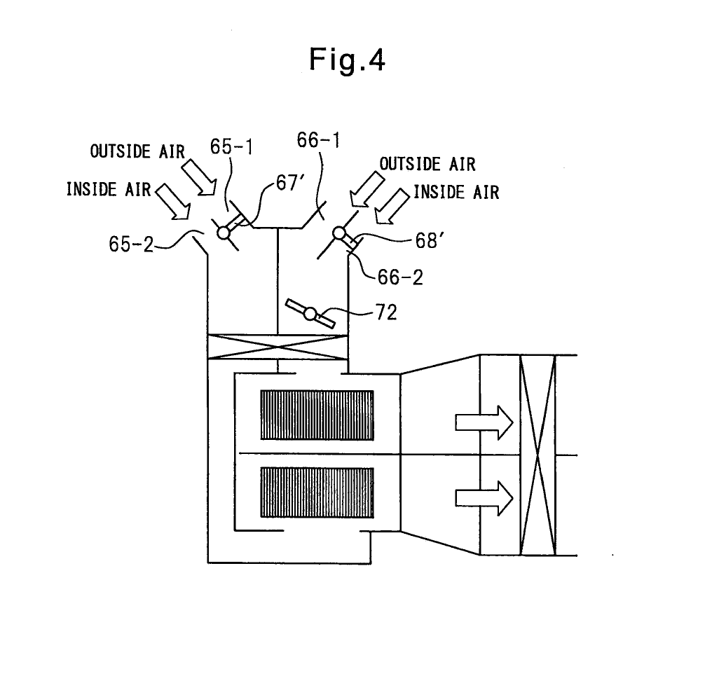

The present invention will be understood more clearly while considering the description of embodiments of the present invention given with reference to the attached drawings as explained below. Below, embodiments of the present invention will be explained with reference to the drawings. In the embodiments, parts of the same configuration are assigned the same reference notations and their explanations are omitted. Parts of the same configuration as the prior art as well are assigned the same reference notations and their explanations are omitted. FIG. 2 is a schematic explanatory view of an inside/outside air suction FOOT mode in an embodiment of the present invention. FIG. 3 is a schematic explanatory view of an outside air suction FOOT mode in an embodiment of the present invention. FIG. 4 is a schematic explanatory view of an inside/outside air suction FOOT mode in a modification of a suction port switching door of an embodiment of the present invention. The vehicular air-conditioning system of the present invention is divided into two parts: an air-conditioning unit 10 and a blower unit 9 which blows air to this air-conditioning unit 10 and the units are called HVAC. The blower unit 9 has a two-layer structure capable of blowing inner and outer air in a two-layer state.

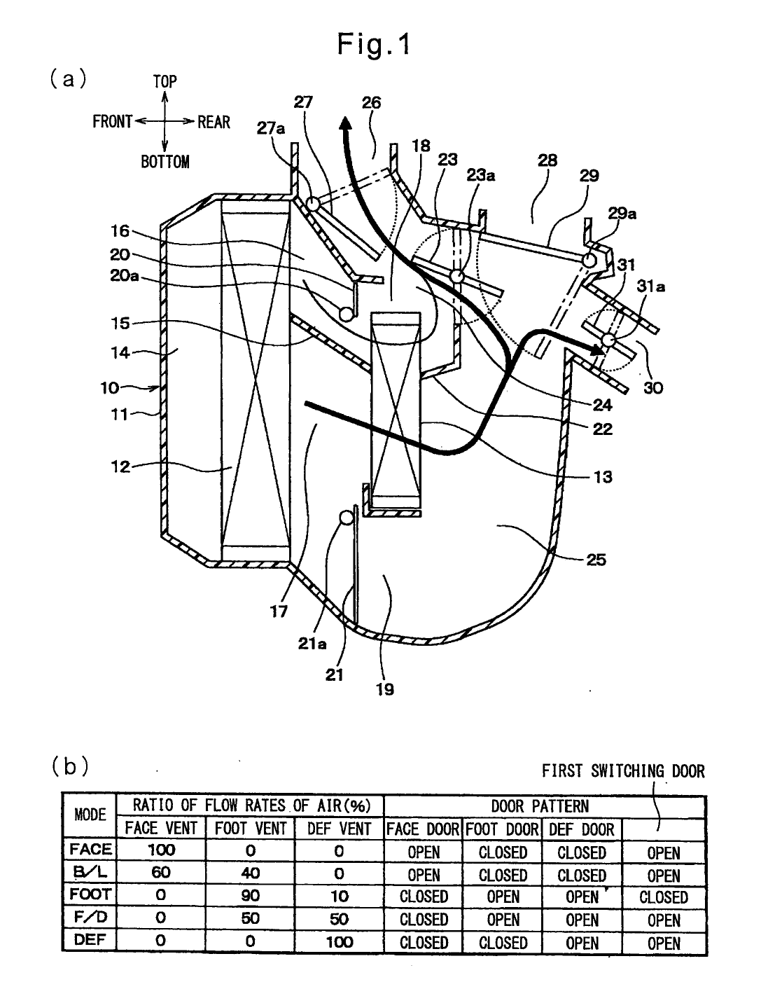

The suction port switching door which opens and closes the air introduction port is comprised of an inside air switching door 67 which is provided at the inside air introduction port 65, an outside air switching door 68 which is provided at the outside air introduction port 66, and an inside/outside air switching door 69. It is possible to set three modes: an inside/outside air suction mode (67: open, 68: open, 69: close), outside air mode (67: close, 68: open, 69: open), and inside air mode (67: open, 68: close, 69: open). The outside air enables a defogging performance to be secured for the windshield, so it becomes possible to suitably select the mode according to the case. The suction port switching door is not necessarily limited to the embodiment of FIG. 2. FIG. 4 shows a modification of the suction port switching door of the present embodiment. In FIGS. 4, 65-1 and 66-1 are outside air introduction ports, while 65-2 and 66-2 are inside air introduction ports. The switching doors 67′, 68′ can be operated to realize the inside/outside air suction mode, outside air mode, and inside air mode. There are also various modes other than these (as one example, see PLT 2).

The centrifugal blower 8 of the blower unit 9 is comprised of an upper fan 52 and a lower fan 53. Here, the embodiments are not limited to the definitions of “upper” and “lower” in the upper fan” and the “lower fan”. In the inside/outside air suction FOOT mode which is shown in FIG. 2, the outside air runs from the outside air introduction port 66 through the first introduction passage 71 and passes through the filter 90 to be sucked in from the top introduction port 91 to the upper fan 52. After that, it is communicated through the first discharge passage 81 to the defroster vents 26 and face vents 28. The inside air runs from the inside air introduction port 65 through the second introduction passage 70 and passes the filter 90 to be sucked in from the bottom introduction port 92 to the lower fan 53. After that, it is communicated through the second discharge passage 82 to the foot vents 30.

The first introduction passage 71 is provided with a throttling door 72, so outside air is blown throttled to the defroster vents 26 and face vents 28. Even if the vehicle speed becomes high and the ram pressure of the introduced outside air rises, the throttling door 72 can be adjusted to adjust the flow rate of air which is blown from the defroster vents 26 and face vents 28. Due to this, even if not opening the defroster door 27 and face door 28 slightly, it is possible to linearly adjust the flow rate of air which flows through the upper side. For this reason, it is possible to keep down the occurrence of a whistling sound due to the slight door opening while adjusting the flow rate of air to a suitable level in response to an increase in the flow rate of air due to the ram pressure at the time when the vehicle is moving at a high speed without detracting from comfort.

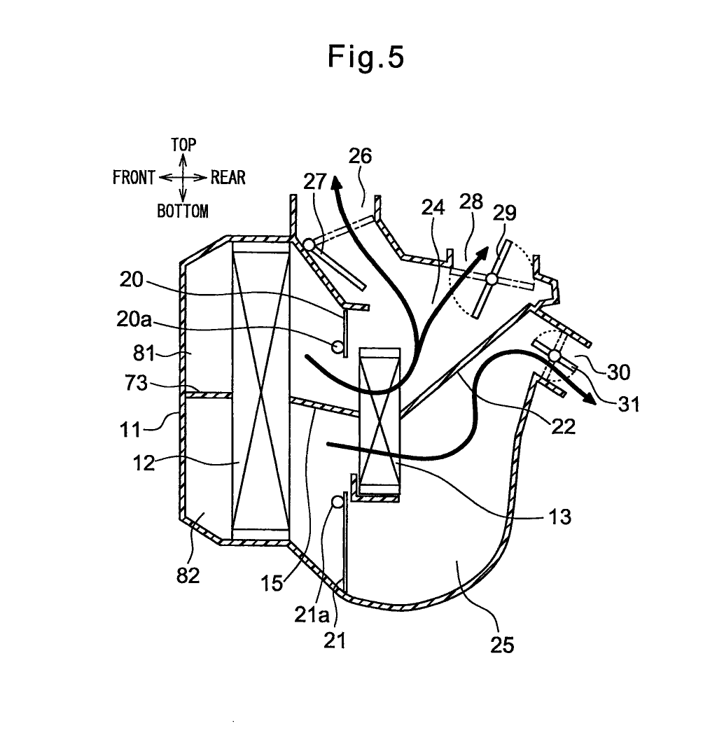

The first discharge passage 81 and the second discharge passage 82 of the blower unit 9 are partitioned by the top/bottom passage partitioning member 73 and continue up to just before the evaporator 12 of the air-conditioning unit. FIG. 5 is a cross-sectional view of an air-conditioning unit of an embodiment of the present invention. Explanations of parts assigned the same reference notations as in FIG. 1(a) are omitted. Unlike FIG. 1(a), there is no first switching door 23. The first upstream side partition member is set at a position dividing the cross-sectional area into about half each for the top and bottom passages. This air-conditioning unit gives one example. The invention is not limited to this. Various modifications are included in the present invention. In an air-conditioning unit of one embodiment of FIG. 5, the air mix doors 20 and 21 are made sliding doors, but pivoting doors may also be used. There are various embodiments for the air mix doors and passage routes.

The passage inside the blower unit (HVAC) is partitioned by the first upstream partitioning member 15 and first downstream partitioning member 22 into an upper (outside air side) air passage and lower (inside air side) air passage. From the FOOT vent 30, high temperature inside air which is warmed by sucking in air at the inside air introduction port 65 is recycled and blown out. On the other hand, from the defroster vents 26 and face vents 28, low humidity warm outside air obtained by sucking in air at the outside air introduction port 66 can be blown out.

Next, referring to FIG. 3, the outside air suction FOOT mode will be explained. In this case, the inside air switching door 67 which is provided at the inside air introduction port 65 is closed, while the outside air switching door 68 which is provided at the outside air introduction port 66 is opened. The inside/outside air switching door 69 is also open. Therefore, outside air is introduced to the first introduction passage 71 and the second introduction passage 70. A throttling door 72 is set at the first introduction passage 71, so outside air is blown to the defroster vents 26 and face vents 28 while throttled. In the FOOT mode, the air flow which strikes the faces of the driver and passengers is prevented from becoming greater. Outside air is blown to the second introduction passage 70 without being throttled, but is communicated with the foot vents through the second discharge passage 82 and blown to the foot parts, so even if the flow rate of air increases, it does not become that much of a problem.

The present embodiment exhibits its advantageous effects in the FOOT mode. Here, there are various variations in the type of the FOOT mode. FIG. 1(b) shows one example of the FOOT mode. Such a FOOT mode is also possible. In the present embodiment, some air is blown from the defroster vents 26 and face vents 28 as well. Of course, the invention is not limited to this. So long as a mode which mainly distributes the air to the FOOT vents 30 (in the present application, this mode called as “FOOT mode”), the advantageous effects of the present embodiment are exhibited. In addition, even in the F/D mode, the advantageous effect arises that the outside air is blown while throttled.

In the present embodiment, the throttling door 72 is set in front of the top introduction port 91 of the upper fan 52, so it is possible to adjust the air flow rate to a suitable level in response to an increase in the air flow rate due to the ram pressure when the vehicle is moving at a high speed without detracting from comfort. Further, it is possible to reduce the amount of work which is imposed on the fan, so along with a reduction in noise, an unexpected energy saving effect arises.

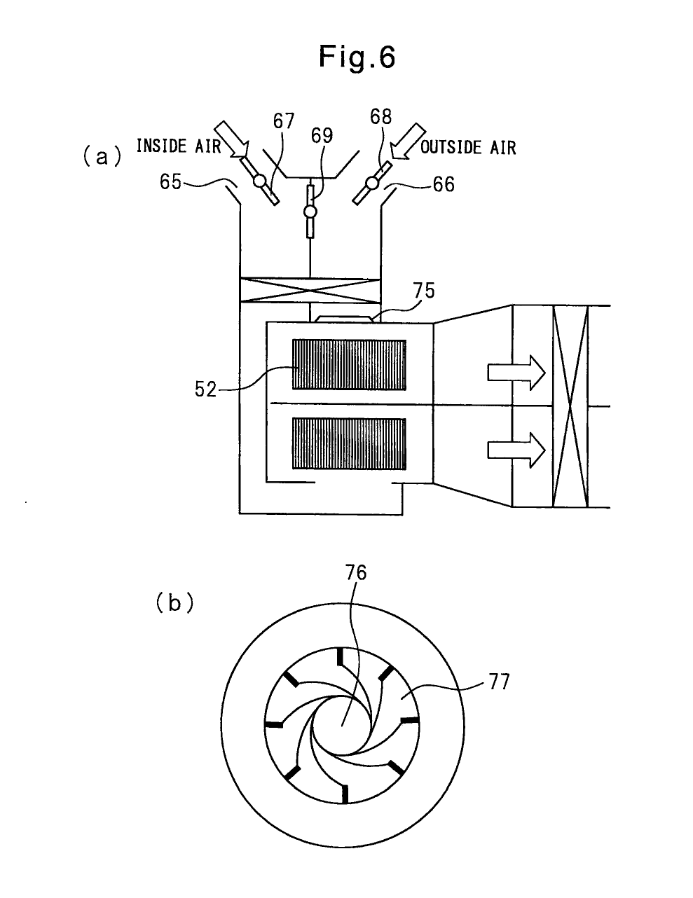

FIG. 6(a) is an explanatory view which shows another embodiment of an outside air flow adjustment mechanism, while FIG. 6(b) is a schematic view which shows an iris shutter type throttling door 75. It is possible to change the diameter of the circular hole 76 at the center part of the plurality of blades 77 and make it function as a throttling door. It may be set at the bell mouth part of the top introduction port 91 of the upper fan 52. The flow rate of air which flows through the first discharge passage 81 and the upper (outside air side) air passage is linearly adjusted. Due to this, it is possible to adjust the air flow rate to a suitable level in response to an increase in the air flow rate due to the ram pressure without detracting from comfort.

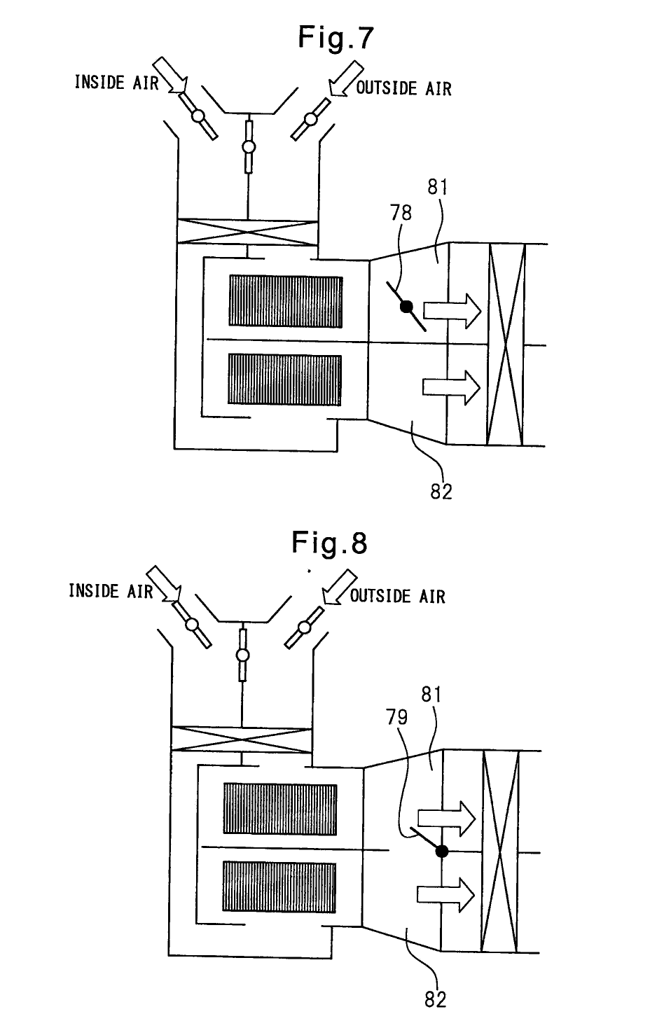

FIGS. 7 and 8 are explanatory views which show other embodiments of an outside air flow adjustment mechanism. FIG. 7 shows an embodiment which provides a throttling door 78 in the first discharge passage 81 from the upper fan 52 to the evaporator 12. In another embodiment of an outside air flow adjustment mechanism of FIG. 8, an opening/closing door 79 is provided at the top/bottom passage partitioning member 73 between the first discharge passage 81 from the upper fan 52 to the evaporator 12 and the second discharge passage 82 from the lower fan 53 to the evaporator 12. The opening/closing door 79 pivots to the first discharge passage side, so it is possible to throttle the flow rate of air passing through the first discharge passage 81. Due to this, it is possible to adjust the air flow rate to a suitable level in response to an increase in the air flow rate due to the ram pressure without detracting from comfort.

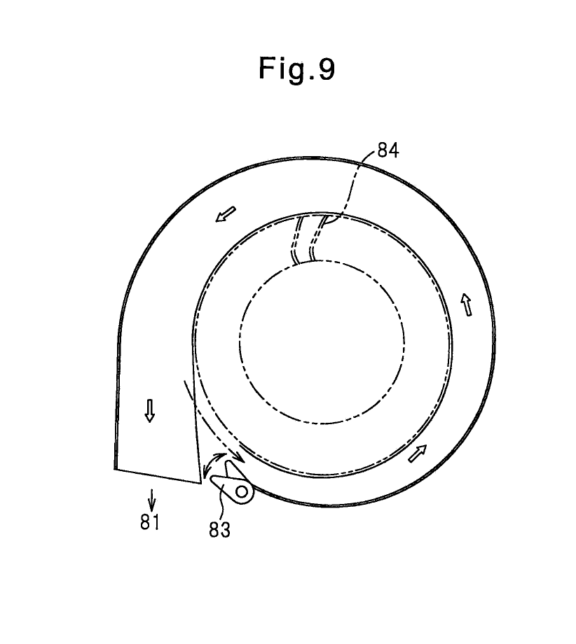

FIG. 9 is an explanatory view which shows another embodiment of an outside air flow adjustment mechanism. The variable nose part clearance mechanism 83 which is provided at the nose part of the upper fan 52 is used to adjust the clearance between the nose part and the outer circumference of the fan blades 84. If greatly increasing the clearance between the nose part and the outer circumference of the fan blades, the fan spins idly and the amount of blown air is reduced. Due to this, it is possible to adjust the air flow rate to a suitable level in response to an increase in the air flow rate due to the ram pressure without detracting from comfort. The variable nose part clearance mechanism 83 rocks in FIG. 9 to adjust the amount of clearance, but the invention is not limited to this. It may also be made to linearly move. Since the fan spins idly whereby the amount of blown air is reduced and the amount of work is reduced, there is also an energy saving effect.

The present invention was described in detail with reference to specific embodiments which were selected for the purpose of illustration, but a person skilled in the art could make various modifications without departing from the basic concept of the present invention the range of the disclosure.

### REFERENCE NOTATIONS LIST

9 blower unit
10 air-conditioning unit
26 defroster vent
28 face vent
30 foot vent
52 upper fan
53 lower fan
70 second introduction passage
71 first introduction passage
81 first discharge passage
82 second discharge passage

1. A vehicular air-conditioning system which is provided with
a blower unit which has an upper fan, a lower fan, switching doors for switching passages, a first introduction passage which sucks inside air or outside air into the upper fan, a second introduction passage which sucks inside air or outside air into the lower fan, and a first discharge passage and second discharge passage which discharge air blown from said upper fan and said lower fan in a two-layer state and
an air-conditioning unit which adjusts the temperature of air blown from said blower unit by an evaporator, air mix door, and heater core and blows air out from defroster vents, face vents, and foot vents into the passenger compartment,
wherein said first introduction passage is an introduction passage in which only outside air is introduced when sucking in inside air and outside air separately, which is provided with an outside air flow adjustment mechanism which limits the amount of outside air which is blown in accordance with the vehicle speed at said first introduction passage or downstream, and which suppresses the occurrence of a whistling sound of said defroster vents or said face vents.

2. The vehicular air-conditioning system as set forth in claim 1, wherein said first introduction passage and said second introduction passage have inside air or outside air introduced by three suction modes of a two-layer inside/outside air mode which sucks in the inside air and outside air separately, an outside air mode, and an inside air mode.

3. The vehicular air-conditioning system as set forth in claim 1, wherein said first introduction passage communicates with said defroster vents and said face vents, and said second introduction passage communicates with said foot vents.

4. The vehicular air-conditioning system as set forth in claim 1, wherein said outside air flow adjustment mechanism is a throttling door which is provided at said first introduction passage.

5. The vehicular air-conditioning system as set forth in claim 1, wherein said outside air flow adjustment mechanism is an iris shutter type throttling door which is provided at said first introduction passage.

6. The vehicular air-conditioning system as set forth in claim 1, wherein said outside air flow adjustment mechanism is a throttling door which is provided at a first discharge passage which extends from said upper fan to said evaporator.

7. The vehicular air-conditioning system as set forth in claim 1, wherein said outside air flow adjustment mechanism is an opening/closing door which is provided at an up-down passage partitioning member between a first discharge passage which extends from said upper fan to said evaporator and a second discharge passage which extends from said lower fan to said evaporator.

8. The vehicular air-conditioning system as set forth in claim 1, wherein said outside air flow adjustment mechanism is a variable nose part clearance mechanism which is provided at a nose part of said upper fan.

9. The vehicular air-conditioning system as set forth in claim 2, wherein said first introduction passage communicates with said defroster vents and said face vents, and said second introduction passage communicates with said foot vents.

10. The vehicular air-conditioning system as set forth in claim 2, wherein said outside air flow adjustment mechanism is a throttling door which is provided at said first introduction passage.

11. The vehicular air-conditioning system as set forth in claim 3, wherein said outside air flow adjustment mechanism is a throttling door which is provided at said first introduction passage.

12. The vehicular air-conditioning system as set forth in claim 2, wherein said outside air flow adjustment mechanism is an iris shutter type throttling door which is provided at said first introduction passage.

13. The vehicular air-conditioning system as set forth in claim 3, wherein said outside air flow adjustment mechanism is an iris shutter type throttling door which is provided at said first introduction passage.

14. The vehicular air-conditioning system as set forth in claim 2, wherein said outside air flow adjustment mechanism is a throttling door which is provided at a first discharge passage which extends from said upper fan to said evaporator.

15. The vehicular air-conditioning system as set forth in claim 3, wherein said outside air flow adjustment mechanism is a throttling door which is provided at a first discharge passage which extends from said upper fan to said evaporator.

16. The vehicular air-conditioning system as set forth in claim 2, wherein said outside air flow adjustment mechanism is an opening/closing door which is provided at an up-down passage partitioning member between a first discharge passage which extends from said upper fan to said evaporator and a second discharge passage which extends from said lower fan to said evaporator.

17. The vehicular air-conditioning system as set forth in claim 3, wherein said outside air flow adjustment mechanism is an opening/closing door which is provided at an up-down passage partitioning member between a first discharge passage which extends from said upper fan to said evaporator and a second discharge passage which extends from said lower fan to said evaporator.

18. The vehicular air-conditioning system as set forth in claim 2, wherein said outside air flow adjustment mechanism is a variable nose part clearance mechanism which is provided at a nose part of said upper fan.

19. The vehicular air-conditioning system as set forth in claim 3, wherein said outside air flow adjustment mechanism is a variable nose part clearance mechanism which is provided at a nose part of said upper fan.
